(19) United States
(12) Patent Application Publication
(10) Pub. No.: US 2026/0313660 A1
(43) Pub. Date: Oct. 8, 2026

(54) Physical Downlink Control Channel (PDCCH) Coverage Enhancements for Non-Terrestrial Networks (NTN)

(71) Applicant: Apple Inc., Cupertino, CA (US)

(72) Inventors: Wei Zeng, Saratoga, CA (US); Chunxuan Ye, San Diego, CA (US); Dawei Zhang, Saratoga, CA (US); Haitong Sun, Saratoga, CA (US)

(21) Appl. No.: 19/482,367

(22) PCT Filed: Apr. 29, 2024
(86) PCT No.: PCT/US2024/026809

§ 371 Date: Nov. 7, 2025

Related U.S. Application Data
(60) Provisional application No. 63/501,965, filed on May 12, 2023.

(51) Int. Cl. H04W 72/232; H04L 5/00; H04W 84/06

(52) U.S. Cl. CPC H04W 72/232; H04L 5/0053; H04L 5/0094; H04W 84/06

(57) ABSTRACT

This disclosure relates to Physical Downlink Control Channel (PDCCH) coverage enhancements for Non-Terrestrial Networks (NTN). In particular, techniques involving the use of segmented PDCCH messages and/or repeated PDCCH messages are disclosed to improve link budget for non-terrestrial communications, especially when long signal propagation distances (e.g., between Earth and a satellite) lead to signal pathloss and greater signal transmission power requirements. In some embodiments described herein, a PDCCH message may be divided into two or more segments for transmission, wherein a first segment of the two or more segments comprises a first portion of Downlink Control Information (DCI) and pointer information, wherein the pointer information identifies a location of a second segment of the two or more segments, and wherein the second segment comprises a second portion of the DCI. In other embodiments, the PDCCH message may be repeated two or more times within a configured slot and/or slot monitoring period.

### TECHNICAL FIELD

The present application relates to wireless devices and wireless networks, including devices, circuits, and methods for providing enhanced coverage for downlink (DL) communication channels, such as the Physical Downlink Control Channel (PDCCH), and especially in the case of non-terrestrial wireless networks.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

Satellite communication is drawing more attention from the industry because of its ability to provide ubiquitous and reliable coverage, i.e., connections anywhere and anytime. One of the main challenges for satellite communications is the link budget, or maximal allowed path loss to achieve certain decoding reliability at the receiver. Satellite communications often suffer from large propagation loss (i.e., path loss) due to the satellite's large distance from the ground (which applies to both uplink and downlink communication). For example, Low Earth Orbit (LEO) satellites may have up to 1,200 miles of altitude. Another issue with satellite communication is the limited total onboard power supply available on most satellites, typically only a few hundred Watts. The limited power needs to be split across multiple concurrent cells/beams, due, in part, to the fact that each satellite needs to cover large areas on Earth's surface. However, attempting to solve this limitation by having a smaller number of beams used per satellite would necessitate more satellites to be used and result in an even higher cost. Satellite communications are also subject to International Telecommunication Union (ITU) Power Flux Density (PFD) limitations.

There are also differences in the ways that User Equipment (UE) devices interact with the telecommunication network, which can particularly impact downlink channels. For example, in the case of Mobile-Originated (MO) calls, a UE can often find a good location/orientation before placing a call, e.g., by pointing a UE antenna towards the direction of the satellite (e.g., with assistance from software). In the case of Mobile-Terminated (MT) calls, on the other hand, the UE is not aware when there is an incoming call/page arriving for the user, and, thus, there may be extra penetration loss (e.g., if the UE is inside of a backpack, inside a car, or there are other blocking materials around the UE). Thus, there is a need for further NR coverage enhancements—especially in the case of downlink channels, such as the PDCCH.

### SUMMARY

In accordance with one or more aspects, a method of transmitting an enhanced Physical Downlink Control Channel (PDCCH) message from a network device is disclosed, the method comprising: configuring a control resource set (CORESET) and a search space for the enhanced PDCCH message, wherein the CORESET comprises at least: frequency domain resources; and a maximum duration; dividing the enhanced PDCCH message into two or more segments, wherein: (a) a first segment of the two or more segments comprises: a first portion of Downlink Control Information (DCI); and first pointer information, (b) the first pointer information identifies a location in a frequency domain and a time domain of a second segment of the two or more segments, and (c) the second segment comprises a second portion of the DCI; and then transmitting each of the two or more segments within the CORESET, wherein the first segment and second segment are non-contiguous in the time domain.

According to some aspects, the network device comprises a non-terrestrial network (NTN) device.

According to other aspects, the maximum duration is greater than a duration of three (3) Orthogonal Frequency Division Multiplexing (OFDM) symbols.

According to other aspects, the search space configuration comprises at least one of: slot periodicity information; slot offset information; information specifying particular symbols within a slot; or PDCCH decoding candidates.

According to still other aspects, a third segment of the two or more segments comprises a third portion of DCI, wherein the second segment further comprises second pointer information, and wherein the second pointer information identifies a location in the frequency domain and the time domain of the third segment. In some aspects, the second segment and third segment may also be non-contiguous with one another in the time domain.

According to some aspects, the first pointer information further comprises at least one of: a slot offset value; a symbol offset value; a CORESET index value; a blind decoding (BD) aggregation level; a BD candidate value; or a number of repetitions with which to transmit each of the two or more segments.

According to other aspects, the first pointer information further comprises an index value, wherein the index value is associated with one or more of: a slot offset value; a symbol offset value; a CORESET index value; a blind decoding (BD) aggregation level; a BD candidate value; or a number of repetitions with which to transmit each of the two or more segments.

In accordance with one or more further aspects, another method of transmitting an enhanced PDCCH message from a network device is disclosed, the method comprising: configuring a control resource set (CORESET) and a search space for the enhanced PDCCH message, wherein the CORESET comprises at least: frequency domain resources; and a maximum duration; transmitting the enhanced PDCCH message within the CORESET, wherein the enhanced PDCCH message is repeated two or more times within a configured slot monitoring period.

According to some aspects, the search space configuration comprises at least one of: slot periodicity information; slot offset information; information specifying particular symbols within a slot; information specifying a number of repetitions within a slot; information specifying an aggregation level for each repetition of the enhanced PDCCH message; or PDCCH decoding candidates.

According to other aspects, a number of times that the enhanced PDCCH message is repeated within the configured slot monitoring period is less than or equal to a number of slots within the configured slot monitoring period.

According to other aspects, the enhanced PDCCH message is transmitted with a same aggregation level across each of the two or more repetitions. According to still other aspects, the enhanced PDCCH message is transmitted with a same blind decoding (BD) candidate for each of the two or more repetitions.

According to some aspects, at least two of the two or more repetitions of the enhanced PDCCH message are transmitted within a same slot. In some such aspects, the search space may comprise information specifying a starting symbol occasion for the repetitions of the enhanced PDCCH message that are transmitted within the same slot. In other such aspects, the search space may comprise information specifying a number of repetitions for the enhanced PDCCH message that are transmitted within the same slot. In still other aspects, the search space configuration may comprise a binary bit mask specifying a starting symbol occasion for each of the repetitions of the enhanced PDCCH message that are transmitted within the same slot.

According to other aspects, at least two of the two or more repetitions of the enhanced PDCCH message are transmitted in different slots.

The various methods and techniques summarized in this section may likewise be performed by a device comprising: a receiver; a transmitter; and a processor configured to perform any of the various methods and techniques summarized herein. The various methods and techniques summarized in this section may likewise be stored as instructions in a non-transitory computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5A illustrates a multi-segment PDCCH message, according to some aspects.

FIG. 5B illustrates exemplary DCI bit fields for a multi-segment PDCCH message, according to some aspects.

FIG. 6A illustrates an example of PDCCH message repetition across multiple slots, according to some aspects.

FIG. 6B illustrates an example of PDCCH message repetition within a single slot, according to some aspects.

FIG. 7 is a flowchart detailing a method of transmitting a multi-segment PDCCH message, according to some aspects.

FIG. 8 is a flowchart detailing a method of transmitting a PDCCH message with repetition within a slot monitoring period, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

This disclosure relates to Physical Downlink Control Channel (PDCCH) coverage enhancements for Non-Terrestrial Networks (NTN). In particular, techniques involving the use of segmented PDCCH messages and/or repeated PDCCH messages are disclosed to improve link budget for non-terrestrial communications, especially in cases wherein long signal propagation distances (e.g., between Earth and a satellite) lead to signal pathloss and greater signal transmission power requirements. In some embodiments described herein, a PDCCH message may be divided into two or more segments for transmission, wherein a first segment of the two or more segments comprises a first portion of Downlink Control Information (DCI) and pointer information, wherein the pointer information identifies a location of a second segment of the two or more segments, and wherein the second segment comprises a second portion of the DCI. In other embodiments, the PDCCH message may be repeated two or more times within a configured slot and/or a slot monitoring period.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

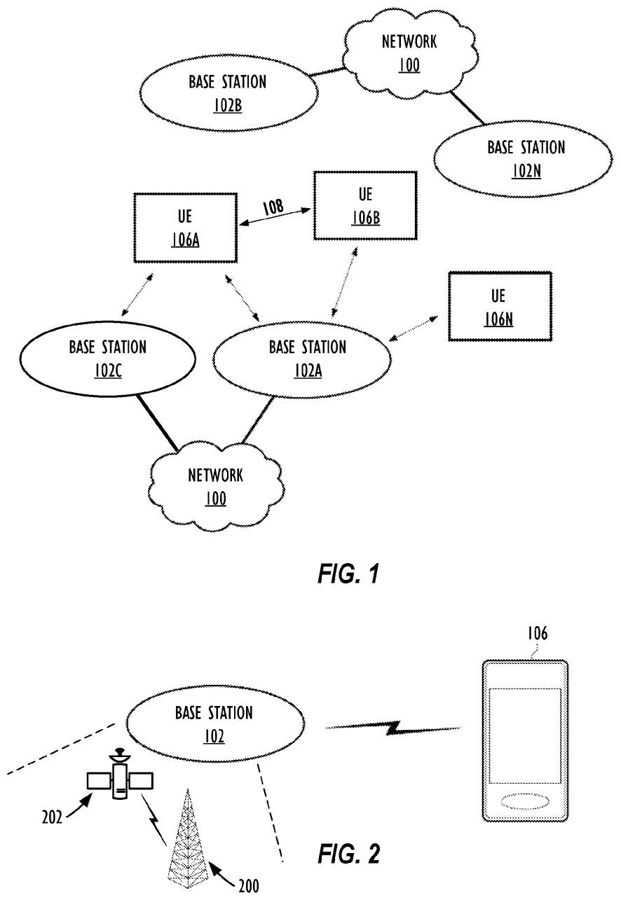

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-N/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

As illustrated in FIG. 2, the base stations 102 may comprise a traditional terrestrial base station 200, a non-terrestrial base station, such as satellite 202, or a combination thereof. For example, in a first, so-called “transparent” or “bent-pipe” mode, the gNB is on the ground (e.g., 200), and the orbiting satellite (e.g., 202) merely acts as a signal repeater (i.e., the gNB does all processing, and the satellite just relays/reflects the processed signals to other places on the Earth). Alternately, in a so-called “non-transparent” or “regenerative” mode, the gNB may be located on the satellite (e.g., 202) and the gateway (e.g., 200) is located on the ground. In non-transparent modes, all the scheduling and signaling occurs onboard the satellite, which may result in faster scheduling decisions and shorter round-trip time (RTT), but is a much more power-hungry design.

### Example Communication Device

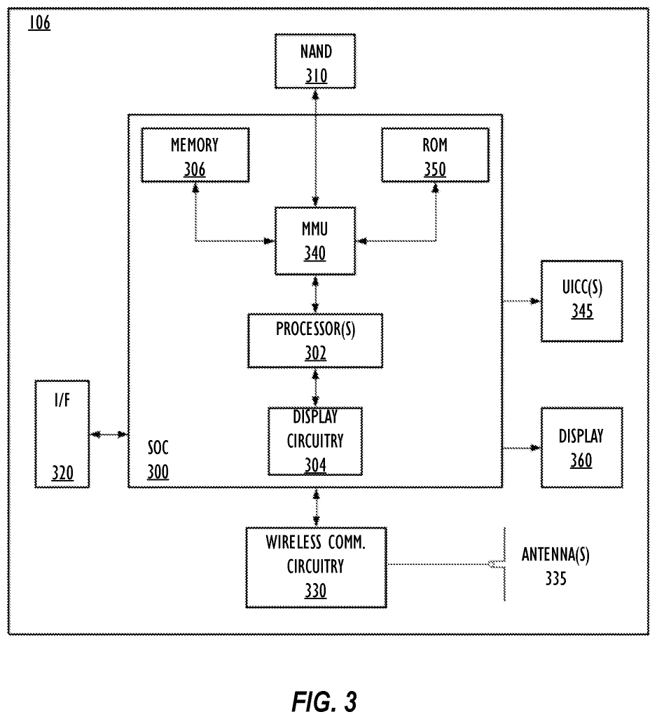

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 (each of which may include an antenna panel), as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

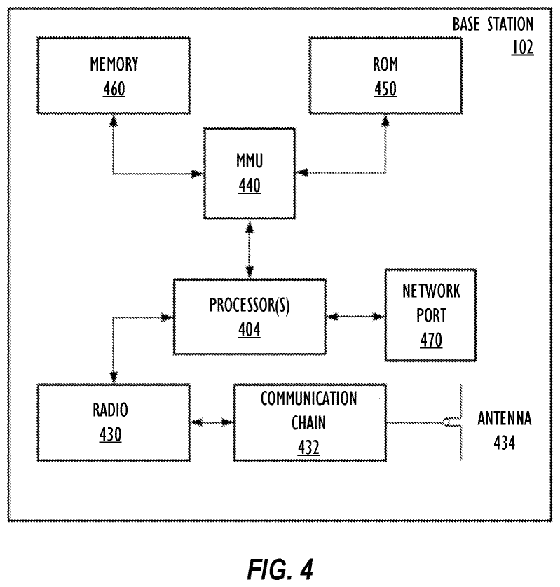

FIG. 4 illustrates an example block diagram of a base station 102, according to some aspects. It is noted that the base station of FIG. 4 is a non-limiting example of a possible base station. As shown, the base station 102 may include processor(s) 304 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas or antenna panels. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Non-Terrestrial Networks (NTNs) and Coverage Limitations

As mentioned above, “non-terrestrial,” e.g., satellite-based, telecommunication has drawn great research interest in recent years, due to its ability provide reliable coverage-even if difficult-to-service places on Earth. In fact, 3GPP has been standardizing NTN support since Release-17. One of the main challenges for satellite communications is the link budget, or the maximal allowed path loss to achieve certain decoding reliability at the receiver. However, NTN can leverage many of the existing NR Coverage enhancements made available in earlier releases, such as PDSCH/PUSCH repetition in connected states, as well as uplink message 3 (Msg3) repetition during initial access.

Release-18 has also focused on specific coverage enhancements for NR-based NTN, but it has mainly been focused on the uplink channels, e.g., using HARQ ACK for Message 4 (Msg4) in the PUCCH and/or performing demodulation reference signal (DM-RS) bundling in the PUSCH. However, NR-based NTN coverage enhancements are still missing for some downlink channels, e.g., the PDCCH is still allotted only up to 3 OFDM symbols, and there is no repetition support for downlink message 2 (Msg2) or message 4 (Msg4) during initial access.

Other current limitations in NR PDCCH reception relate to control resource set (CORESET) configuration and search space configuration. For example, the CORESET may configure the particular resources in the time and frequency domains to use for the PDCCH reception. The frequency domain resources may be specified by a bit map indicating which Resource Block Groups (RBGs) are to be used for PDCCH (e.g., a control channel element (CCE) may be made up of 6 resource element groups (REGs), and each REG may be made up of one resource block (RB) in the frequency domain and 1 OFDM symbol in the time domain). The search space configuration may involve setting a periodicity and offset (e.g., in terms of a number of slots), a number of symbols used within a given slot, and/or which resources to use as decoding candidates.

### Multi-Stage and Segmented PDCCH Messages

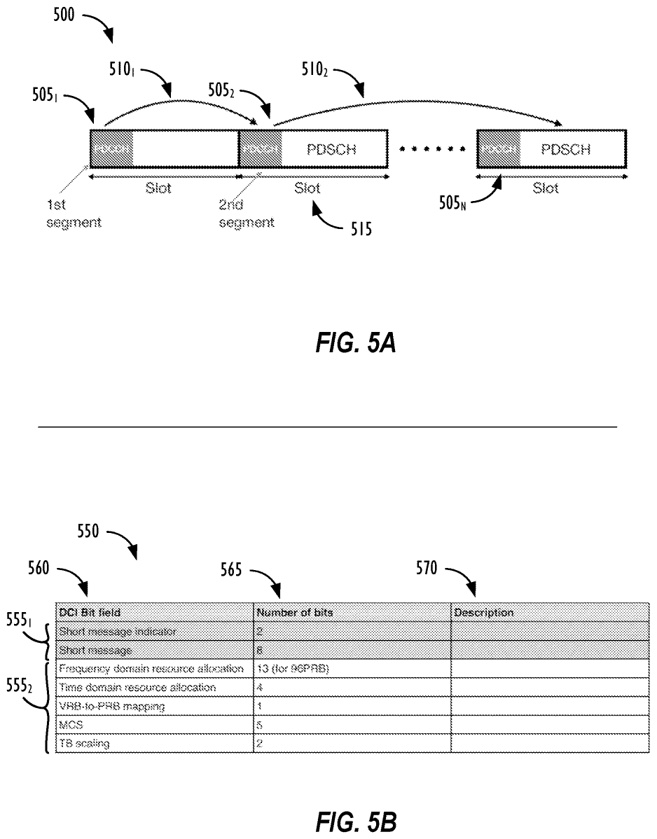

According to some aspects, the link budget for PDCCH reception may be enhanced via the usage of a multi-stage, i.e., segmented, PDCCH message. For example, turning now to FIG. 5A, a multi-segment PDCCH message 500 is illustrated, according to some aspects. The PDCCH message 500 may be divided up into multiple segments, e.g., segment 505₁, 505₂, . . . 505ₙ, which may be transmitted is multiple “stages.” According to some aspects, each segment 505 may comprise a portion of Downlink Control Information (DCI) and pointer (510) information, wherein the pointer information identifies a location in a frequency domain and a time domain of a next segment of the two or more segments that the PDCCH has been divided into. For example, pointer information 510₁ may be stored in segment 505₁ and point to a location in frequency and time of segment 505₂, and so forth, with each pointer 510ₙ pointing to the next segment of the PDCCH message 510ₙ₊₁. The subsequent segments of the PDCCH message may each comprise additional portions of the DCI. According to some aspects, each PDCCH segment 505 may be transmitted within its own slot 515.

The smaller number of information bits transmitted per segment (i.e., compared to a non-segmented PDCCH message) enhances the decoding reliability for the overall PDCCH message, especially with respect to NTN communications. According to some aspects, each PDCCH segment can be a legacy PDCCH (i.e., using up to 3 OFDM symbols), while, according to other aspects, one or more PDCCH segments can be an enhanced PDCCH (i.e., using more than 3 OFDM symbols and/or being transmitted with repetition).

Turning now to FIG. 5B, an exemplary DCI bit field table 550 for a multi-segment PDCCH message is illustrated, according to some aspects. Table 550 is illustrated with a column for DCI bit field labels (560), a column to specify the number of bits (565) associated with each respective DCI bit field, as well as a column to hold a description (570) associated with each respective DCI bit field.

In the example of FIG. 5B, a DCI bit field table for an exemplary “Paging PDCCH” is shown, although it is to be understood that this example is given merely for illustrative purposes and that other types of PDCCH messages may similarly benefit from the techniques described herein. As is known, a Paging PDCCH may be scrambled by a Paging Radio Network Temporary Identifier (P-RNTI). A P-RNTI may be used to scramble the cyclic redundancy check (CRC) bits belonging to DCI Format 1_0 when allocating PDSCH resources for the transmission of Paging messages, or when using the PDCCH to encapsulate a “Short Message.” A “Short Message” may be used to indicate that System Information content has changed and needs to be re-acquired. It can also be used to indicate emergency warnings, such as Earthquake and Tsunami Warnings.

A Paging PDCCH is currently around 35 bits in size, not counting other reserved bits, and it can be divided naturally into two parts. For example, a Part 1 (555₁) may contain data that is not related to paging PDSCH scheduling information, such as a Short Message indicator and Short messages, but it may also include one or more new fields including location information specifying a time/frequency location for the next segment of DCI information, as will be discussed in further detail below. A Part 2 (555₂) of the Paging PDCCH may then contain other information, such as the paging PDSCH scheduling information (e.g., frequency domain resource allocation (FDRA), time domain resource allocation (TDRA), virtual resource block (VRB)-to-physical resource block (PRB) mappings, modulation and coding scheme (MCS), transport block (TB) size scaling factors, etc.).

As described above, the one or more new fields including DCI location information for the next segment of DCI information (i.e., the so-called “pointer information”) may include: time domain location fields (e.g., slot offset, symbol offset, CORESET index, etc.), as well as blind decoding-related fields (e.g., aggregation level, which may be the same value that is used for the other DCI information and/or blind decoding (BD) candidate information, which may also be the same value that is used for the other DCI information). According to some aspects, e.g., for simplicity, only a single BD candidate may be used, however, other network configurations may want more flexibility, and thus include two (or more) BD candidates.

According to some aspects, the pointer information that specifies a time/frequency location for the next segment of DCI information may be independently encoded with different bits in the DCI information. However, if it is desired that the pointer information be encoded with less data storage overhead, the pointer information may alternatively be jointly encoded using a table with finite number of rows. One example of a joint coding table is shown in TABLE 1, below.

TABLE 1

| Row | | Symbol | CORESET | Aggregation | BD | # of |
|---|---|---|---|---|---|---|
| Index | Slot Offset | Offset | index | Level | candidate | repetitions |
| 1 | 0 (i.e., same slot) | 7 | 3 | 16 | 0 | 1 |
| 2 | 1 (i.e., next slot) | 0 | 5 | 16 | 1 | 2 |
| 3 | 2 (i.e., slot after | 0 | 4 | 16 | 0 | 2 |
| | next) | | | | | |
| . . . | . . . | . . . | . . . | . . . | . . . | . . . |

As shown in TABLE 1, transmitting a row index value of ‘2’ could be used to encode that the next PDCCH segment will occur with a slot offset of 1 (i.e., in the next slot), with a symbol offset of 0 (i.e., beginning in the first symbol of the next slot), using CORESET index 5, aggregation level 16, and BD candidate 1. A given table joint coding table could comprise 2 rows, 4 rows, 8 rows, etc., depending on how many bits of overhead a given implementation is willing to dedicate to signaling the row index number associated with the desired the pointer information.

As will now be discussed in further detail, according to some aspects, a PDCCH message may alternately (or additionally) be repeated a number of times, i.e., in order to improve its likelihood of being successfully decoded at a receiving device. As such, according to some embodiments, and as shown in the last (i.e., far right-hand) column of joint coding TABLE 1, above, a joint coding table may also optionally specify a number of repetitions for each PDCCH segment (i.e., two repetitions, in the case of row index value ‘2’). As may now be understood, specifying a PDCCH segment repetition value may thus provide a blending of the advantageous effects of both PDCCH segmentation and PDCCH repetition for NTN transmissions in a single implementation.

According to some aspects, the information shown in table 550 may be transmitted in a maximum number of segments, e.g., a maximum of two segments, or three segments, or four segments, etc. Additionally, other types of PDCCH messages (i.e., other than Paging PDCCH, as discussed in the example above) could have other types of configuration data, e.g., MIMO configuration data, or modem processing data, etc., that may lend itself to a particular segment transmission sequencing and/or division of the PDCCH data into segments (including a maximum total number of segments), based on what information needs to be known (and when) by the UE in order to perform the necessary functions.

### PDCCH Message Repetition (Intra-Slot and Inter-Slot)

As mentioned above, according to some aspects, a PDCCH may be additionally (or alternatively) repeated across multiple consecutive slots (and/or or multiple times within a same slot) in order to improve its changes of being received successfully for NTN transmissions.

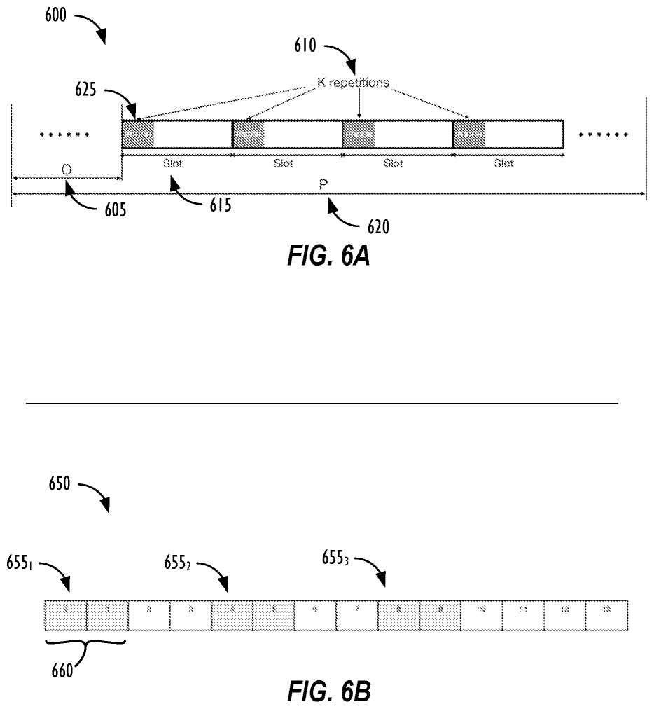

Turning now to FIG. 6A, an example of PDCCH message repetition 600 across multiple slots 615 (i.e., “inter-slot repetition”) is illustrated, according to some aspects. Existing search space configuration parameters include “monitoringSlotPeriodcityAndOffset,” which may be used to configure: a Periodicity, P (620), e.g., in terms of a number of slots; a slot offset within each period, O (605); and a number of repetitions, K (610), that the PDCCH (625) will be repeated within the period, P (620). The network can configure the repetition factor K (610), e.g., in terms of a number of slots in which the PDDCH (625) will be repeated. In the example of FIG. 6A, a repetition factor of K=4 slots is shown. According to some aspects, the repetition factor, K, may be configured in the system information block (SIB), which can also support the paging PDCCH, while, according to other aspects, the repetition factor, K, may be configured in the search space configuration after the RRC connection is completed. In still other aspects, the repetition information could be hardcoded into the Specification itself.

According to some aspects, various constraints may be placed upon the repetition factor, e.g., to simplify the UE detection process, e.g.: K must always be less than or equal to the period (P); a same aggregation level must be used across all repetitions; and/or a same blind decoding (BD) candidate must be used across all repetitions.

Turning now to FIG. 6B, according to still other aspects, a PDCCH message 650 may be repeated within a single slot (i.e., “intra-slot repetition”). For example, NR already supports multiple gap-span monitoring patterns, such as: (2,2), (4,3) and (7,3), wherein the first number in the pairing indicates how many symbols apart each occasion must be, and the second number in the pairing represents the maximum length of the occasion. Thus, a (4,3) monitoring pattern would refer to occasions with starting symbols that are 4 (or more) symbols apart from each other and that each have a duration of 3 (or fewer) symbols.

Thus, according to some aspects disclosed herein, the search space configuration can further indicate multiple starting symbols for PDCCH monitoring (e.g., using the ‘monitoringSymbolsWithinSlot’ bitmap). According to some aspects described herein, the only parameters that may need to be signaled in order to fully specify the search space configuration are the starting occasion of the repetition (S) and the number of repetitions (R). (In some implementations, for simplicity, it may be desired to always start from the first monitoring occasion, i.e., set S=0.) As mentioned above, in order to simplify UE detection, it may also be desirable to keep a same aggregation level and a same BD candidate across all repetitions.

As shown in FIG. 6B, an exemplary search space has been configured with three intra-slot PDCCH repetitions, e.g., 655₁, 655₂, and 655₃, and each repetition has a duration (660) of two OFDM symbols in length. Thus, this example would meet the (4,3) monitoring pattern described above, i.e., each starting symbol occasion is at least 4 symbols apart, and the length of each occasion is fewer than 3 symbols (i.e., it is 2 symbols, as may be specified by the selected CORESET). This search space configuration illustrated in FIG. 6B may also be represented by a MonitoringSymbolWithinSlot bit map of: [1 0 0 0 1 0 0 0 1 0 0 0 0 0] (wherein values of ‘1’ correspond to symbols within the slot where the PDCCH is transmitted), and/or it may simply be represented by the parameter values of S=0 and R=3. As may be appreciated, the farther apart that the repetition spans are, the more relaxed the configuration is for a UE, because the UE will have more time to do the necessary processing between repetitions.

It is also to be understood that the intra-slot repetition illustrated in FIG. 6A and the inter-slot repetition illustrated in FIG. 6B may be used in combination with each other or, alternately, only a single form of PDCCH repetition may be employed in a given implementation.

### Exemplary Methods

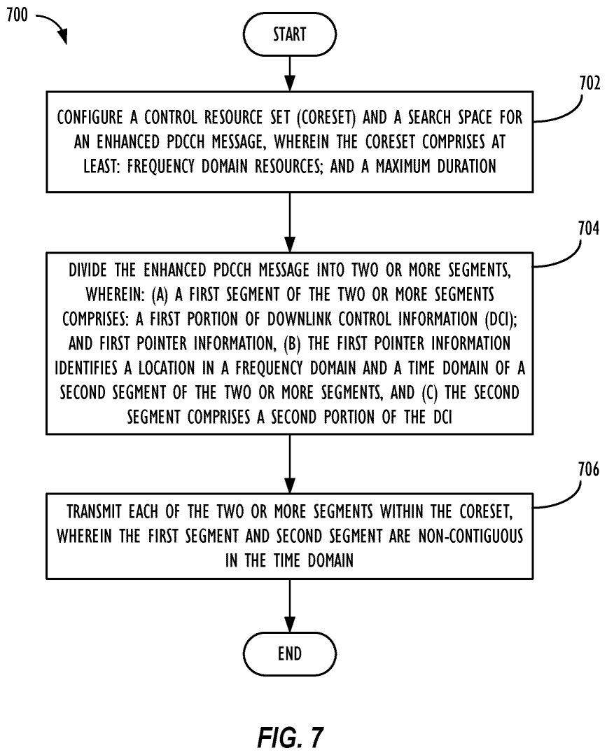

Turning now to FIG. 7, a flowchart detailing a method 700 of transmitting a multi-segment PDCCH message is shown, according to some aspects. First, at block 702, the method 700 may begin by configuring a control resource set (CORESET) and a search space for an enhanced PDCCH message, wherein the CORESET comprises at least: frequency domain resources; and a maximum duration in the time domain (e.g., in terms of a number of OFDM symbols). Next, at block 704, the method 700 may divide the enhanced PDCCH message into two or more segments, wherein: (a) a first segment of the two or more segments comprises: a first portion of Downlink Control Information (DCI); and first pointer information, (b) the first pointer information identifies a location in a frequency domain and a time domain of a second segment of the two or more segments, and (c) the second segment comprises a second portion of the DCI. Finally, at block 706, the method 700 may transmit each of the two or more segments within the CORESET, wherein the first segment and second segment are non-contiguous in the time domain.

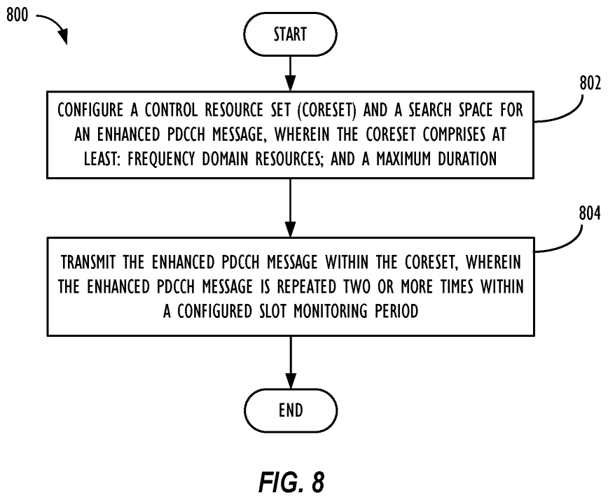

Turning now to FIG. 8, a flowchart detailing a method 800 of transmitting a PDCCH message with repetition within a slot monitoring period is shown, according to some aspects. First, at block 802, the method 800 may configure a control resource set (CORESET) and a search space for an enhanced PDCCH message, wherein the CORESET comprises at least: frequency domain resources; and a maximum duration. Next, at block 804, the method 700 may transmit the enhanced PDCCH message within the CORESET, wherein the enhanced PDCCH message is repeated two or more times within a configured slot monitoring period.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method of transmitting an enhanced Physical Downlink Control Channel (PDCCH) message from a network device, the method comprising:
configuring a control resource set (CORESET) and a search space for the enhanced PDCCH message, wherein the CORESET comprises at least: frequency domain resources; and a maximum duration;
dividing the enhanced PDCCH message into two or more segments, wherein:
(a) a first segment of the two or more segments comprises: a first portion of Downlink Control Information (DCI); and first pointer information,
(b) the first pointer information identifies a location in a frequency domain and a time domain of a second segment of the two or more segments, and
(c) the second segment comprises a second portion of the DCI; and
transmitting each of the two or more segments within the CORESET, wherein the first segment and second segment are non-contiguous in the time domain.

2. The method of claim 1, wherein the network device comprises a non-terrestrial network (NTN) device.

3. The method of claim 1, wherein the maximum duration is greater than a duration of three (3) Orthogonal Frequency Division Multiplexing (OFDM) symbols.

4. The method of claim 1, wherein the search space configuration comprises at least one of: slot periodicity information; slot offset information; information specifying particular symbols within a slot; or PDCCH decoding candidates.

5. The method of claim 1, wherein a third segment of the two or more segments comprises a third portion of DCI, wherein the second segment further comprises second pointer information, and wherein the second pointer information identifies a location in the frequency domain and the time domain of the third segment.

6. The method of claim 5, wherein the second segment and third segment are non-contiguous in the time domain.

7. The method of claim 1, wherein the first pointer information further comprises at least one of: a slot offset value; a symbol offset value; a CORESET index value; a blind decoding (BD) aggregation level; a BD candidate value; or a number of repetitions with which to transmit each of the two or more segments.

8. The method of claim 1, wherein the first pointer information further comprises an index value, wherein the index value is associated with one or more of: a slot offset value; a symbol offset value; a CORESET index value; a blind decoding (BD) aggregation level; a BD candidate value; or a number of repetitions with which to transmit each of the two or more segments.

9. The method of claim 1,
wherein the CORESET further comprises: frequency domain resources; and a maximum duration; and
wherein the enhanced PDCCH message is repeated two or more times within a configured slot monitoring period.

10.-21. (canceled)

22. A network device comprising:
a receiver;
a transmitter;
at least one interface; and
a processor configured to cause the network device to:
configure a control resource set (CORESET) and a search space for an enhanced Physical Downlink Control Channel (PDCCH) message, wherein the CORESET comprises at least: frequency domain resources; and a maximum duration;
divide the enhanced PDCCH message into two or more segments, wherein:
(a) a first segment of the two or more segments comprises: a first portion of Downlink Control Information (DCI); and first pointer information,
(b) the first pointer information identifies a location in a frequency domain and a time domain of a second segment of the two or more segments, and
(c) the second segment comprises a second portion of the DCI; and
transmit each of the two or more segments within the CORESET, wherein the first segment and second segment are non-contiguous in the time domain.

23. The network device of claim 22, wherein the network device comprises a non-terrestrial network (NTN) device.

24. The network device of claim 22, wherein the maximum duration is greater than a duration of three (3) Orthogonal Frequency Division Multiplexing (OFDM) symbols.

25. The network device of claim 22, wherein a third segment of the two or more segments comprises a third portion of DCI, wherein the second segment further comprises second pointer information, and wherein the second pointer information identifies a location in the frequency domain and the time domain of the third segment.

26. The network device of claim 25, wherein the second segment and third segment are non-contiguous in the time domain.

27. The network device of claim 22, wherein the CORESET further comprises: frequency domain resources; and a maximum duration; and wherein the enhanced PDCCH message is repeated two or more times within a configured slot monitoring period.

28. A baseband processor configured to cause a network device to:
configure a control resource set (CORESET) and a search space for an enhanced Physical Downlink Control Channel (PDCCH) message, wherein the CORESET comprises at least: frequency domain resources; and a maximum duration;
divide the enhanced PDCCH message into two or more segments, wherein:
(a) a first segment of the two or more segments comprises: a first portion of Downlink Control Information (DCI); and first pointer information,
(b) the first pointer information identifies a location in a frequency domain and a time domain of a second segment of the two or more segments, and
(c) the second segment comprises a second portion of the DCI; and
transmit each of the two or more segments within the CORESET, wherein the first segment and second segment are non-contiguous in the time domain.

29. The baseband processor of claim 28, wherein the network device comprises a non-terrestrial network (NTN) device.

30. The baseband processor of claim 28, wherein the maximum duration is greater than a duration of three (3) Orthogonal Frequency Division Multiplexing (OFDM) symbols.

31. The baseband processor of claim 28, wherein the search space configuration comprises at least one of: slot periodicity information; slot offset information; information specifying particular symbols within a slot; or PDCCH decoding candidates.

32. The baseband processor of claim 28, wherein the first pointer information further comprises at least one of: a slot offset value; a symbol offset value; a CORESET index value; a blind decoding (BD) aggregation level; a BD candidate value; or a number of repetitions with which to transmit each of the two or more segments.
